(19) United States
(12) Patent Application Publication
(10) Pub. No.: US 2009/0021678 A1
(43) Pub. Date: Jan. 22, 2009

(54) Flexible Display Apparatus and Method for Producing the Same

(76) Inventors: Se-Hwan Son, Daejeon Metropolitan City (KR); Hyeon Choi, Daejeon Metropolitan City (KR)

Correspondence Address: MCKENNA LONG & ALDRIDGE LLP, 1900 K STREET, NW, WASHINGTON, DC, 20006, US

(21) Appl. No.: 12/086,995

(22) PCT Filed: Dec. 29, 2006
(86) PCT No.: PCT/KR2006/005892

§ 371 Date: Jun. 24, 2008

(30) Foreign Application Priority Data
Dec. 30, 2005 (KR) 10-2005-0134882

(51) Int. Cl. G02F 1/1333

(52) U.S. Cl. 349/122; 349/158; 349/187

(57) ABSTRACT

Disclosed are a flexible display apparatus and a method for producing the same. The flexible display apparatus includes a flexible substrate; a planarization layer which has an area smaller than an area of the flexible substrate and is formed on the flexible substrate; a display device which is formed on the planarization layer; and a protective layer which is provided on the flexible substrate to cover both the planarization layer and the display device.

### TECHNICAL FIELD

The present invention relates to a flexible display apparatus that effectively prevents moisture or oxygen from permeating a planarization layer using a protective layer, and a method for producing the same.

This application claims priority from Korean Patent Application No. 10-2005-0134882 filed on Dec. 30, 2005 in the Korean Intellectual Property Office, the disclosure of which is incorporated herein by reference in its entirety.

### BACKGROUND ART

Generally, a flexible display apparatus is a display apparatus in which a display device is formed on a flexible substrate instead of a thick glass substrate to show visual information even though the apparatus is folded or bent.

Examples of a flexible substrate that is applied to the flexible display apparatus may include a plastic substrate made of an organic material, a substrate having a structure where the organic material and an inorganic material are laminated, and a substrate including metal such as thin stainless steel or aluminum.

Examples of the display device that is applied to the flexible display apparatus include a cholesteric LCD, a PDLC (Polymer Dispersed Liquid Crystal), an electrophoretic device, and an OLED (organic light emitting device).

In the display device, gas permeability of oxygen or moisture to a flexible substrate is important according to the type of display device.

Particularly, since the organic light emitting diode is very vulnerable to oxygen or moisture, there are problems in that performance and a life of the organic light emitting diode are reduced due to permeation of oxygen or moisture.

To avoid the above problems, Korean Patent Registration No. 0300425 discloses a plastic substrate of an organic electroluminescent device that is provided with a plurality of gas barrier layers.

The gas barrier layer may be made of various types of metal oxides as disclosed in Korean Patent Laid-Open Publication No. 2004-0111403, or an organic-inorganic mixture as disclosed in Korean Patent Laid-Open Publication No. 2003-0074783.

As an example of the flexible display apparatus with the above gas barrier layer, in the case of the flexible display apparatus that is shown in FIG. 4, a gas barrier layer 120 is interposed between a flexible substrate 110 and a display device 130, and a protective layer 140 is provided on the flexible substrate 110 to cover the display device 130.

Meanwhile, the flexible display apparatus may be produced using a stainless steel foil substrate (Z. Xie et al, Chemical Physics Letters, 381, 691 (2003)) that is developed in order to effectively prevent permeation of oxygen or moisture, or a flexible substrate that is provided with a laminate of aluminum foil and a plastic substrate (Y. Li et al, Applied Physics Letters, 86, 153508 (2005)).

In the case that the above-mentioned flexible substrate is used, in order to assure the desirable planarization of the flexible substrate required in the flexible display apparatus, an organic planarization layer is provided on the flexible substrate.

To be more specific, as shown in FIG. 5, a planarization layer 220 is interposed between a flexible substrate 210 including a plastic substrate 211 and a metal thin layer 212 and a display device 230. A protective layer 240 is provided on the flexible substrate 210 to cover the display device 230.

In connection with this, the planarization layer 220 has almost the same area as the flexible substrate 210, and the area that is larger than that of the protective layer 240. Thus, an edge of the planarization layer 220 is exposed.

As shown in FIG. 5, the protective layer 240 prevents moisture or oxygen from permeating from above, and the flexible substrate 210 prevents moisture or oxygen from permeating from below. However, as described above, since the edge of the planarization layer 220 is exposed, there is a problem in that it is impossible to prevent moisture or oxygen from permeating the planarization layer 220 from the side.

### DISCLOSURE

### Technical Problem

An object of the present invention is to provide a flexible display apparatus that effectively prevents moisture or oxygen from permeating a planarization layer using a protective layer, and a method for producing the same.

### Technical Solution

According to an aspect of the present invention, a flexible display apparatus includes a flexible substrate; a planarization layer which has an area smaller than an area of the flexible substrate and is formed on the flexible substrate; a display device which is formed on the planarization layer; and a protective layer which is provided on the flexible substrate to cover both the planarization layer and the display device.

The flexible substrate may include a resin layer and a metal layer formed on the resin layer.

The resin layer may be made of at least one selected from the group consisting of PET (polyethylene terephthalate), polyester, PEN (polyethylene naphthalate), PEEK (polyetheretherketone), PC (polycarbonate), PES (polyethersulfone), PI (polyimide), PAR (polyarylate), PCO (polycyclic olefin), and polynorbornene.

The metal layer may be made of at least one selected from the group consisting of aluminum and stainless steel.

The metal layer may be formed on the resin layer using a laminating process to provide the flexible substrate.

It is preferable that the planarization layer has a thickness of 10 μm and less. It is preferable that an interval between an edge of the planarization layer and an edge of the flexible substrate is 10 cm and less.

The display device may be any one of a cholesteric LCD, a PDLC (Polymer Dispersed Liquid Crystal), an electrophoretic device, and an OLED (organic light emitting device).

It is preferable that the protective layer has an area that is larger than an area of the planarization layer and smaller than an area of the flexible substrate.

The protective layer may form a plastic sheet including a gas barrier material, and be attached to the flexible substrate.

Alternatively, a material selected from the group consisting of a gas barrier material, an organic material, and a mixture thereof may be applied to the flexible substrate to form any one of a single-layer type protective layer and a multilayered protective layer on the flexible substrate.

According to another aspect of the present invention, a method for producing a flexible display apparatus includes a) providing a flexible substrate, b) forming a planarization layer that has an area smaller than an area of the flexible substrate on the flexible substrate, c) forming a display device on the planarization layer, and d) forming a protective layer on the flexible substrate to cover both the planarization layer and the display device.

A metal layer may be formed on a resin layer using a laminating process to provide the flexible substrate in step a).

The resin layer may be made of at least one selected from the group consisting of PET (polyethylene terephthalate), polyester, PEN (polyethylene naphthalate), PEEK (polyetheretherketone), PC (polycarbonate), PES (polyethersulfone), PI (polyimide), PAR (polyarylate), PCO (polycyclic olefin), and polynorbornene.

The metal layer may be made of at least one selected from the group consisting of aluminum and stainless steel.

The planarization layer may have a thickness of 10 μm and less in step b).

The planarization layer may be formed on the flexible substrate so that an interval between an edge of the planarization layer and an edge of the flexible substrate is 10 cm and less in step b).

The display device may be any one of a cholesteric LCD, a PDLC (Polymer Dispersed Liquid Crystal), an electrophoretic device, and an OLED (organic light emitting device) in step c).

It is preferable that the protective layer has an area that is larger than an area of the planarization layer and smaller than an area of the flexible substrate in step d).

The protective layer may form a plastic sheet including a gas barrier material, and be attached to the flexible substrate in step d).

Alternatively, a material selected from the group consisting of a gas barrier material, an organic material, and a mixture thereof may be applied to the flexible substrate to form any one of a single-layer type protective layer and a multilayered protective layer on the flexible substrate.

### ADVANTAGEOUS EFFECTS

According to the present invention, since a planarization layer is disposed in a protective layer, it is possible to effectively prevent moisture or oxygen from permeating the planarization layer.

### DESCRIPTION OF DRAWINGS

The above and other features and advantages of the present invention will become more apparent by describing in detail preferred embodiments thereof with reference to the attached drawings in which:

FIG. 1 is a side view of a flexible display apparatus according to the present invention;

FIG. 2 is a view showing attachment of a plastic substrate and a metal thin layer using a laminating process according to the present invention;

FIG. 3 is a plan view of a flexible substrate and a planarization layer according to the present invention; and

FIGS. 4 and 5 are side views of known flexible display apparatuses.

### EXPLANATION OF THE SIGNS THAT ARE THE MAIN PART OF THE DRAWINGS

10: flexible substrate
11: plastic substrate
12: metal thin layer
20: planarization layer
21: inclined side
30: display device
40: protective layer
51,52: roller

### MODE FOR INVENTION

Hereinafter, a detailed description will be given of the present invention with reference to the accompanying drawings.

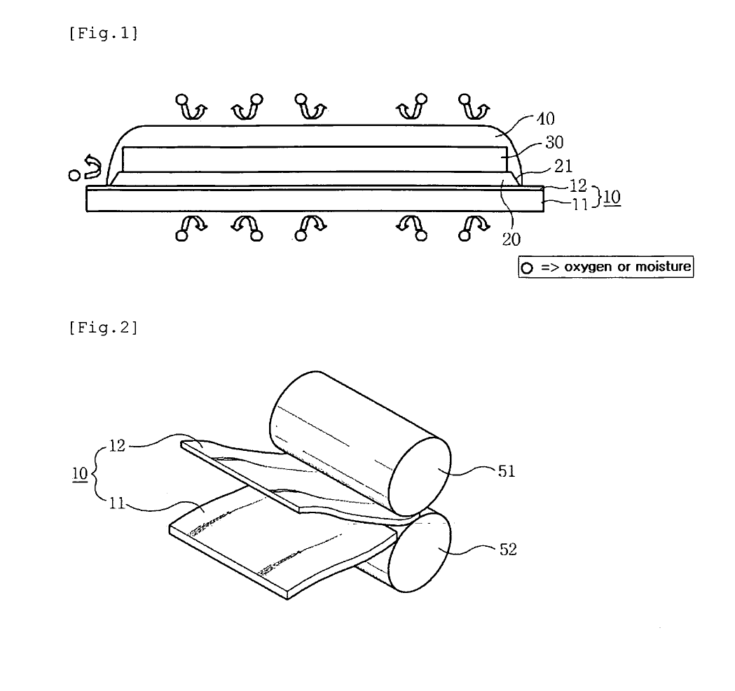

As shown in FIG. 1, a flexible display apparatus according to the present invention is provided with a flexible substrate 10 and a display device 30.

In connection with this, a planarization layer 20 is interposed between the flexible substrate 10 and the display device 30. A protective layer 40 that is provided on the flexible substrate 10 covers both the planarization layer 20 and the display device 30.

The flexible substrate 10 includes a plastic substrate 11 that is a resin layer, and a metal thin layer 12 that is formed on the plastic substrate 11 and formed of a metal layer.

The plastic substrate 11 may be made of one or more which is selected from the group consisting of PET (polyethylene terephthalate), polyester, PEN (polyethylene naphthalate), PEEK (polyetheretherketone), PC (polycarbonate), PES (polyethersulfone), PI (polyimide), PAR (polyarylate), PCO (polycyclic olefin), and polynorbornene.

The metal thin layer 12 may act as a gas barrier layer that prevents gas such as oxygen or moisture from permeating the plastic substrate 11.

The metal thin layer 12 is a thin film that is made of at least one selected from the group consisting of aluminum and stainless steel. In consideration of economic efficiency, it is preferable that an aluminum thin layer be used as the metal thin layer 12. A type of metals is not limited thereto and various types of metals may be applied to the metal thin layer 12.

Since the metal thin layer 12 is a conductor, a short circuit may occur between the electrode of the display device 30 and a driving circuit (not shown) due to the metal thin layer 12. Accordingly, an oxide layer may be formed on the metal thin layer 12 using a plasma treatment process or an electrochemical process in order to prevent the short circuit.

The planarization layer 20 is provided between the flexible substrate 10 and the display device 30 so as to assure the desirable planarization of the flexible substrate 10 required in the flexible display apparatus.

Substantially, the roughness of the flexible substrate 10 is an important factor in the flexible display apparatus. In the case of the organic light emitting diode, it is required that the roughness is 1 nm and less. In the case of the LCD, it is required that the roughness is 5 nm and less. However, in the case of the most metal thin layer, it is difficult to satisfy the above-mentioned conditions due to the characteristic of the production process. Thus, it is necessary to use the planarization layer 20.

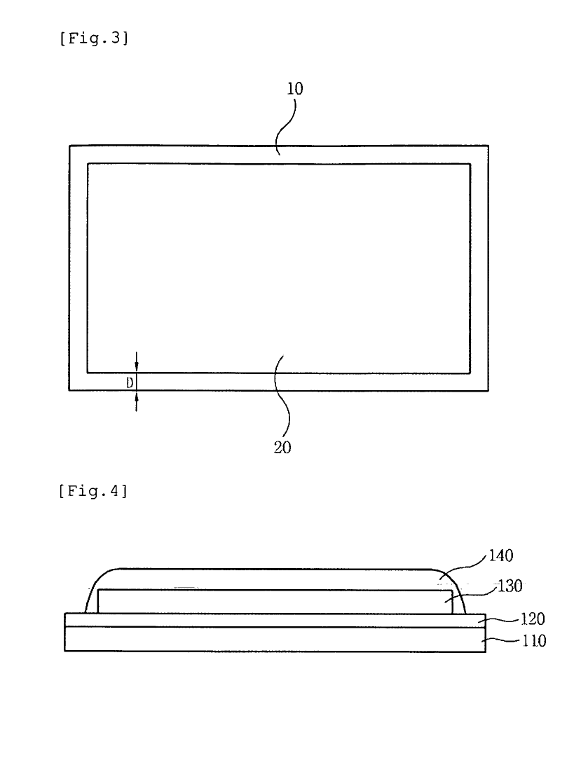

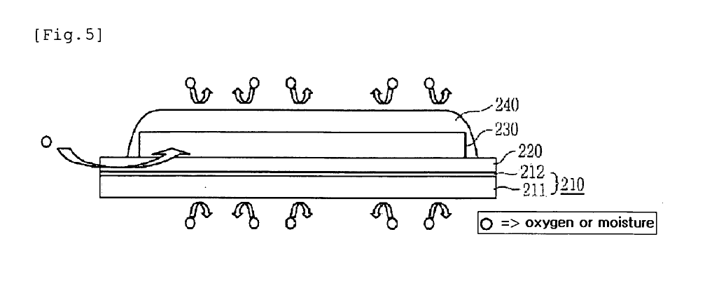

As shown in FIG. 3, the planarization layer 20 is formed on the flexible substrate 10 so that an interval (D) between the edge of the planarization layer 20 and the edge of the flexible substrate 10 is 10 cm and less. That is, the planarization layer 20 is provided to have the area smaller than that of the flexible substrate 10, and formed on the flexible substrate 10.

The thickness of the planarization layer 20 is not limited as long as flexibility of the flexible display apparatus is not significantly reduced. Preferably, the thickness of the planarization layer is 10 μm and less.

It is preferable that the edge of the planarization layer 20 have an inclined side 21 in order to prevent a short circuit of the electrode line (not shown) of the display device 30.

Examples of the display device 30 that is formed on the planarization layer 20 may include a cholesteric LCD (Liquid Crystal Display), a PDLC (Polymer Dispersed Liquid Crystal), an electrophoretic device, and an OLED (organic light emitting device).

The cholesteric LCD has a planar alignment spiral structure, and a characteristic in which light is selectively reflected according to a twisting direction and a pitch of a repeating structure.

The PDLC is one of liquid crystal cells that are applied to the liquid crystal display (LCD), and is characterized in that transmittance of light is controlled according to the scattering of light and it is unnecessary to use a polarizing plate.

Examples of the electrophoretic type of device may include a device using capsulated particles which is manufactured by E Ink Corp., a device using charged particles which is manufactured by Bridgestone Corp., a device using spinning of particles which is manufactured by Gyricon, Inc., and a device using movement of particles in a lateral direction.

The OLED (organic light emitting device) has a structure in which electrodes and organic layers are evenly deposited. The organic light emitting diode has a multilayered structure in which four organic layers including a hole injection layer, a hole transport layer, a light emitting layer, and an electron transport layer, and electrodes are evenly deposited. This is not shown in FIG. 1. If voltage is applied between two electrodes, the hole is injected from the anode to the organic layers, and the electron is injected from the cathode to the organic layers. After the injected hole and electron are combined with each other in the light emitting layer to form an exciton, light is emitted in the course of deactivating the exciton, and red, green, and blue colors are displayed according to the type of light emitting layer.

As shown in FIG. 1, the protective layer 40 is provided on the flexible substrate 10 to cover both the display device 30 and the planarization layer 20. Accordingly, both the display device 30 and the planarization layer 20 are provided in a region that is formed, by the protective layer 40 and the flexible substrate 10. That is, both the display device 30 and the planarization layer 20 are sealed in the region that is formed by the protective layer 40 and the flexible substrate 10.

In connection with this, the protective layer 40 is provided to have the area that is smaller than that of the flexible substrate 10 and larger than that of the planarization layer 20.

Hereinafter, a description will be given of a method for producing the flexible display apparatus according to the present invention.

The method for producing the flexible display apparatus includes a) preparing the flexible substrate, b) forming the planarization layer having the area that is smaller than that of the flexible substrate on the flexible substrate, c) forming the display device on the planarization layer, and d) forming the protective layer on the flexible substrate to cover both the planarization layer and the display device.

In step a), the metal thin layer 12 may be formed on the plastic substrate 11 using a vacuum thermal evaporation process, an e-beam evaporation process, a sputtering process or the like. As shown in FIG. 2, it is preferable that the plastic substrate 11 and the metal thin layer 12 be attached to each other using the laminating process. The metal thin layer 12 may be simply formed on the plastic substrate 11 using the laminating process without using a costly device.

That is, as shown in FIG. 2, the plastic substrate 11 and the metal thin layer 12 are pressed between a pair of rotating rollers 51 and 52 to easily provide the metal thin layer 12 on the plastic substrate 11. The use of the laminating process is more desirable in comparison with a process using a known vacuum device in the viewpoint of mass production, enlargement in size, and economic efficiency.

In connection with this, in the case that the metal thin layer 12 is attached to the plastic substrate 11 using the above laminating process, it is preferable that the metal thin layer have the thickness of 100 μm and less so as to assure desirable flexibility of the flexible substrate 10. In the case that the metal thin layer 12 is very thick, the flexibility of the flexible substrate 10 may be reduced.

In step b), a polyimide-based polymer, a photoacryl-based polymer, an overcoat material, or BCB (benzocyclobutene) may be applied using a coating process such as bar coating and spin coating to provide the planarization layer 20 on the flexible substrate 10. Thereby, the roughness of the flexible substrate 10 may be improved. Additionally, the planarization layer 20 may be formed using a SOG (spin-on-glass) material.

In step c), the display device 30 may be formed on the planarization layer 20 using a vacuum deposition process or a solution coating process such as inkjet printing, screen printing, roll coating, and spin coating.

In step d), a sheet may be produced using a plastic including a gas barrier material, and then attached to the flexible substrate 10 using an adhesive to form the protective layer 40 on the flexible substrate 10.

In connection with this, examples of the plastic material may include PET (polyethylene terephthalate), polyester, PEN (polyethylene naphthalate), PEEK (polyetheretherketone), PC (polycarbonate), PES (polyethersulfone), PI (polyimide), PAR (polyarylate), PCO (polycyclic olefin), and polynorbornene.

Any gas barrier material that is known in the art may be used as the gas barrier material.

Examples of the adhesive may include epoxies and acrylates that are capable of being cured by heat or ultraviolet rays.

Furthermore, in step d), the material that is selected from the group consisting of the gas barrier material, the organic material, and a mixture thereof may be applied on the flexible substrate 10 to form the protective layer 40.

A single-layer type protective layer 40 may be formed on the flexible substrate 10 using any one material that is selected from the group consisting of the gas barrier material, the organic material, and the mixture thereof. Alternatively, a multilayered protective layer 40 having two or more layers may be formed using two or more materials that are selected from the group consisting of the gas barrier material, the organic material, and the mixture thereof.

In connection with this, the protective layer 40 may be formed by means of a vacuum thermal evaporation process, an e-beam evaporation process, a sputtering process, or a sol-gel coating process using an oxide- or nitride-based material that is the gas barrier material.

The oxide-based material may be at least one of silicon oxides, boron oxides, phosphorus oxides, sodium oxides, potassium oxides, lead oxides, titanium oxides, magnesium oxides, and barium oxides. Examples of the nitride-base material may include silicon nitrides.

In the flexible display apparatus that is produced using the method according to the present invention, the protective layer 40 that is provided on the flexible substrate 10 covers both the planarization layer 20 and the display device 30. That is, the planarization layer 20 and the display device 30 are sealed by the protective layer 40. Accordingly, it is possible to effectively prevent moisture or oxygen from permeating the planarization layer 20.

1. A flexible display apparatus comprising:
a flexible substrate;
a planarization layer that has an area smaller than an area of the flexible substrate and is formed on the flexible substrate;
a display device that is formed on the planarization layer; and
a protective layer that is formed on the flexible substrate to cover both the planarization layer and the display device.

2. The flexible display apparatus according to claim 1, wherein the protective layer has an area that is larger than an area of the planarization layer and smaller than an area of the flexible substrate.

3. The flexible display apparatus according to claim 1, wherein an interval between an edge of the planarization layer and an edge of the flexible substrate is 10 cm and less.

4. The flexible display apparatus according to claim 1, wherein the protective layer forms a plastic sheet including a gas barrier material and is attached to the flexible substrate.

5. The flexible display apparatus according to claim 1, wherein a material selected from the group consisting of a gas barrier material, an organic material, and a mixture thereof is applied to the flexible substrate to form any one of a single-layer type protective layer and a multilayered protective layer on the flexible substrate.

6. The flexible display apparatus according to claim 1, wherein the planarization layer has a thickness of 10 μm and less.

7. The flexible display apparatus according to claim 1, wherein the display device is any one of a cholesteric LCD, a PDLC (Polymer Dispersed Liquid Crystal), an electrophoretic device, and an OLED (organic light emitting device).

8. The flexible display apparatus according to claim 1, wherein the flexible substrate includes a resin layer and a metal layer formed on the resin layer.

9. The flexible display apparatus according to claim 8, wherein the resin layer is made of at least one selected from the group consisting of PET (polyethylene terephthalate), polyester, PEN (polyethylene naphthalate), PEEK (polyetheretherketone), PC (polycarbonate), PES (polyethersulfone), PI (polyimide), PAR (polyarylate), PCO (polycyclic olefin), and polynorbornene.

10. The flexible display apparatus according to claim 8, wherein the metal layer is made of at least one selected from the group consisting of aluminum and stainless steel.

11. The flexible display apparatus according to claim 8, wherein the metal layer is formed on the resin layer using a laminating process to provide the flexible substrate.

12. A method for producing a flexible display apparatus, comprising the steps of:
a) providing a flexible substrate;
b) forming a planarization layer that has an area smaller than an area of the flexible substrate on the flexible substrate;
c) forming a display device on the planarization layer; and
d) forming a protective layer on the flexible substrate to cover both the planarization layer and the display device.

13. The method for producing a flexible display apparatus according to claim 12,
wherein the protective layer has an area that is larger than an area of the planarization layer and smaller than an area of the flexible substrate in step d).

14. The method for producing a flexible display apparatus according to claim 12, wherein the planarization layer is formed on the flexible substrate so that an interval between an edge of the planarization layer and an edge of the flexible substrate is 10 cm and less in step b).

15. The method for producing a flexible display apparatus according to claim 12, wherein the protective layer forms a plastic sheet including a gas barrier material and is attached to the flexible substrate in step d).

16. The method for producing a flexible display apparatus according to claim 12, wherein a material selected from the group consisting of a gas barrier material, an organic material, and a mixture thereof is applied to the flexible substrate to form any one of a single-layer type protective layer and a multilayered protective layer on the flexible substrate in step d).

17. The method for producing a flexible display apparatus according to claim 12, wherein the planarization layer has a thickness of 10 μm and less in step b).

18. The method for producing a flexible display apparatus according to claim 12, wherein the display device is any one of a cholesteric LCD, a PDLC (Polymer Dispersed Liquid Crystal), an electrophoretic device, and an OLED (organic light emitting device) in step c).

19. The method for producing a flexible display apparatus according to claim 12, wherein a metal layer is formed on a resin layer using a laminating process to provide the flexible substrate in step a).

20. The method for producing a flexible display apparatus according to claim 19, wherein the resin layer is made of at least one selected from the group consisting of PET (polyethylene terephthalate), polyester, PEN (polyethylene naphthalate), PEEK (polyetheretherketone), PC (polycarbonate), PES (polyethersulfone), PI (polyimide), PAR (polyarylate), PCO (polycyclic olefin), and polynorbornene.

21. The method for producing a flexible display apparatus according to claim 19, wherein the metal layer is made of at least one selected from the group consisting of aluminum and stainless steel.
